(19) United States
(12) Patent Application Publication
(10) Pub. No.: US 2003/0167693 A1
(43) Pub. Date: Sep. 11, 2003

(54) Automatic door opening and closing apparatus with lock

(75) Inventor: Christopher E. Mainini, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN

(21) Appl. No.: 10/094,884

(22) Filed: Mar. 11, 2002

(51) Int. Cl. E05F 15/10

(52) U.S. Cl. 49/28; 49/279; 49/280; 49/281

(57) ABSTRACT

An apparatus for automatically actuating and securing a door has been shown and described. The automatic door system non-destructively retrofits a conventional door to allow actuation of the door. The automatic door system integrates a lock mechanism and a door actuation mechanism. The automatic door system allows hands-free operation and is suitable for use with pets or humans. The automatic door system controls the arc of the door swing and duration that the door remains open based upon the requestor activating the automatic door system. The automatic door system provides additional security over traditional mechanical locks. Further, the automatic door system allows access profiles to be customized to the requestor.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

This invention relates to an apparatus for unlocking, opening, closing and locking a door automatically. More specifically, this invention relates to an apparatus that can be installed in an existing conventional door installation without modification of the existing door lock mechanism.

2. Related Prior Art

Automatic doors are well known to relieve the additional burden of opening the door to those who are otherwise encumbered or unable to operate a conventional door mechanism, as in the case of a physical handicap. However, currently available automatic door locks require major modifications to the door jam and the doorknob assembly. Both the automatic lock itself and the installation are relatively expensive. Further, these prior-art automatic door locks use a significant amount of electrical power and require connection to an alternating current power supply.

The use of the prior art automatic door locks and openers is easily justified in commercial and special needs applications. However, the use of prior art automatic locks and door openers is more difficult to justify for commonplace applications such as pet ingress and egress. The pet owner typically resorts to installation of a mechanical pet door to provide an opening to allow a pet to come and go as it pleases. Conventional pet doors present a different set of problems for the pet owner. While relatively inexpensive, the pet door installation is unnecessarily difficult in that it often requires the removal of the door to cut an opening in the existing door. The effect of the door in which the pet door is installed must be substantially flat and must be within a given thickness range. Because the pet door installation permanently defaces the door, it is generally not permitted in a landlord/tenant situation and often not desirable to a homeowner.

The pet door itself presents a number of additional problems. First, its materials and size limit the security of a conventional pet door. Further, the sizes of the available openings of pet doors are limited, which prevents them from being used with many larger pets. Finally, conventional pet doors generally offer poor weather sealing capabilities and are not otherwise energy efficient. And, as the description implies, a pet door offers no direct benefit to the human resident of the dwelling in the way of assistance unlocking and opening the door. Accordingly, there is a need for an alternative system for opening, closing, locking and unlocking an existing conventional door to accommodate both people and animals which addresses the limitation of the prior art.

### BRIEF SUMMARY OF THE INVENTION

An apparatus for automatically actuating and securing a door, or automatic door system, is provided. The automatic door system is generally designed to retrofit an existing conventional door but can be incorporated in a new door. The automatic door system includes a housing that is securely mounted to the entry door in a conventional manner. Extending from the housing is a drive shaft of the door actuator motor disposed within the housing. An actuator arm connects the drive shaft to the doorframe. A sensor activates the automatic door system. In the illustrated embodiment, the sensor is an external sensor in electrical communication with the control circuit in the housing.

A door lock mechanism of the automatic door system includes locking pin that extends into a recession in the doorframe, thereby securing the door in a closed position. A conventional metal lock plate is generally utilized to add support to a wood doorframe. The locking pin retracts to allow to opening of the door. A lock driver operates the locking pin. Various types of lock drivers can be used to operate the locking pin including a direct drive, a motor driven cam and a solenoid. The door lock mechanism is selected to provide security irrespective of other locks used with the door. It is intended to serve as a primary lock when the structure is unoccupied and can be supplemented with interior locks, such as door chains, when the structure is occupied. This avoids the need for a separate lock, such as a conventional keyed lock, which would obviate the benefit of hands free operation. However, for extra security, a deadbolt can be used in conjunction with the door lock mechanism. Typically, the conventional lock is not be part of the automatic door system and is left unlocked; however, the conventional lock can be integrated and activate the automatic door system when the door is unlocked using the key.

The automatic door system includes a motor for driving the door actuator, a locking mechanism, and a sensor generally linked by a controller and a power supply. The sensor receives a signal from an external source requesting operation of the automatic door system. The type of sensor used depends on the anticipated user and the anticipated use of the automatic door system.

The automatic door system includes a number of safety features. These include manual overrides for both the door lock mechanism and the door actuator mechanism. A release disengages the locking pin from the lock driver and allows the locking pin to be retracted to an unlocked position. This provides for access through the door incorporating the automatic door system in the event of an emergency situation, system malfunction or power loss. Similarly, the door actuator mechanism can be disengaged to allow the door to operate in a conventional manual mode. In addition, a blockage sensor works in conjunction with the door actuator mechanism to prevent the door from attempting to open or close should the path of the door blocked. Those skilled in the art will recognize the various sensor types that can be used to implement the blockage sensor including, but not limited to, a pressure-sensitive release and an infrared sensor.

An automatic door system used with an entry door would require at least a moderate level of security such as a coded radio frequency signal to prevent unwelcome guests from entering the house. However, for an internal door where assistance is needed but security is not required, a pressure sensitive switch would suffice. If the intended users are both pet and human, the user would be required to carry a broadcasting device such as an infrared, magnetic or radio frequency transmitter worn by a pet, for example, on a collar or carried by a human, for example, on a keychain. However, if the intended user is strictly human, the biometric sensor, keypad or other device not operable by a pet could be used.

The controller provides the necessary processing function to verify the identity of the requester for security purposes, to perform authentication functions, to operate the door actuator and to coordinate the activity of the lock mechanism. The controller receives and processes the signal received by the sensor. By providing direct control over the door actuator mechanism, the controller allows the door to be opened and remain open for a specified period of time before closing. When combined with requestor identification, this time period can vary to accommodate various users particular needs. Requestor identification is accomplished through any of a variety of techniques. The controller provides the capability to assign a profile to a particular requestor that limits access times.

In addition, the automatic door system incorporates a limiting switch that controls the movement range of the door. The limiting switch primarily defines the maximum range of movement for the door and prevents the door actuator mechanism from attempting to move the door beyond a specified position. In a more sophisticated embodiment, the controller handles the limiting switch function. By controlling the door actuator mechanism, the controller limits how far the door opens depending upon who is requesting access.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an illustration of a conventional entry door incorporating an automatic door system of the present invention;

FIG. 2 is an illustration, in partial section, of the housing of the automatic door system of the present invention;

FIG. 3 is an illustration, in partial section, of the housing of an alternative embodiment of the automatic door system of the present invention; and

FIG. 4 is a block diagram of the automatic door system of the present invention.

### DETAILED DESCRIPTION OF THE INVENTION

An apparatus for automatically actuating and securing a door, or automatic door system, is provided and shown generally at 10 in the figures. The automatic door system 10 is generally designed to retrofit an existing conventional door but can be incorporated in a new door.

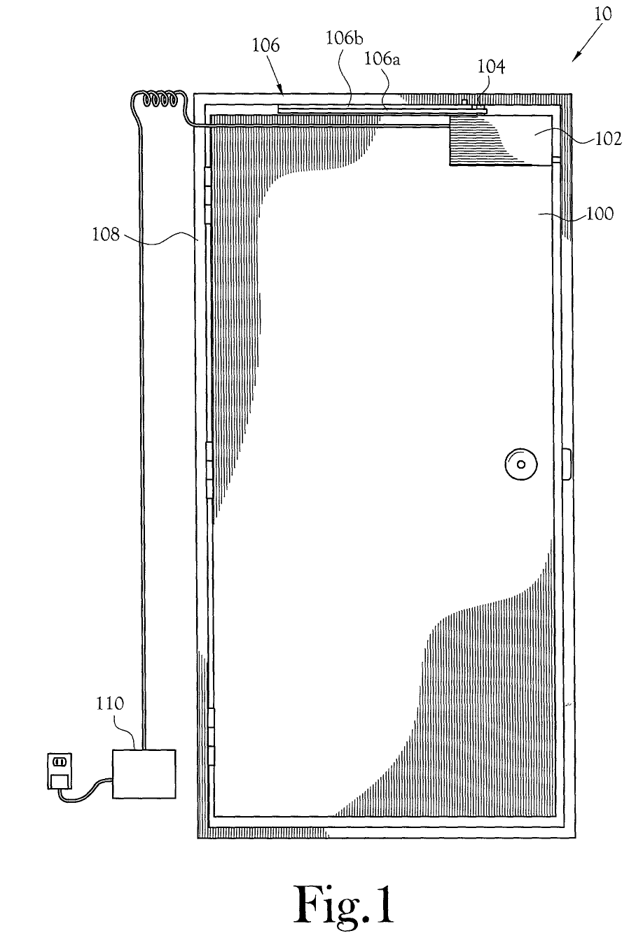

FIG. 1 illustrates a conventional entry door 100 using the automatic door system 10 of the present invention. The automatic door system 10 includes a housing 102 that is securely mounted to the entry door 100 in a conventional manner. Extending from the housing 102 is a drive shaft 104 of the door actuator motor disposed within the housing 102. An actuator arm 106 connects the drive shaft 104 to the doorframe 108. In the illustrated embodiment, the actuator arm 106 includes a first elongated member 106a connected to the drive shaft 104 at a first end and pivotally connected to the second elongated member 106b at second end. The second elongated member 106b is pivotally connected to the doorframe 108 substantially proximate to the drive shaft 104. A sensor 110 activates the automatic door system 10. In the illustrated embodiment, the sensor 110 is an external sensor 110 in electrical communication with the control circuit in the housing 102. Those skilled in the art will recognize that the sensor 110 could be mounted internally within the housing 102 depending upon the type of communication used. Further, those skilled in the art will recognize that the housing 102 could be connected to the doorframe 108 and the actuator arm 106 connected to the door 100 without departing from the scope and spirit of the present invention.

FIG. 2 illustrates one embodiment of the automatic door system 10 of the present invention in greater detail. The housing 102 is cut-away to reveal the internal mechanism that operates the automatic door system. Visible is the door actuator motor 202, the control circuit 204 and the door lock mechanism 206. The door lock mechanism includes locking pin 208 that extends into a recession in the doorframe 108, thereby securing the door 100 in a closed position. A conventional metal lock plate 212 is generally utilized to add support to a wood doorframe 108. The locking pin 208 retracts to allow to opening of the door 100. A lock driver 214 operates the locking pin 208. In the illustrated embodiment, the lock driver 214 is a solenoid is used to drive the locking pin 208.

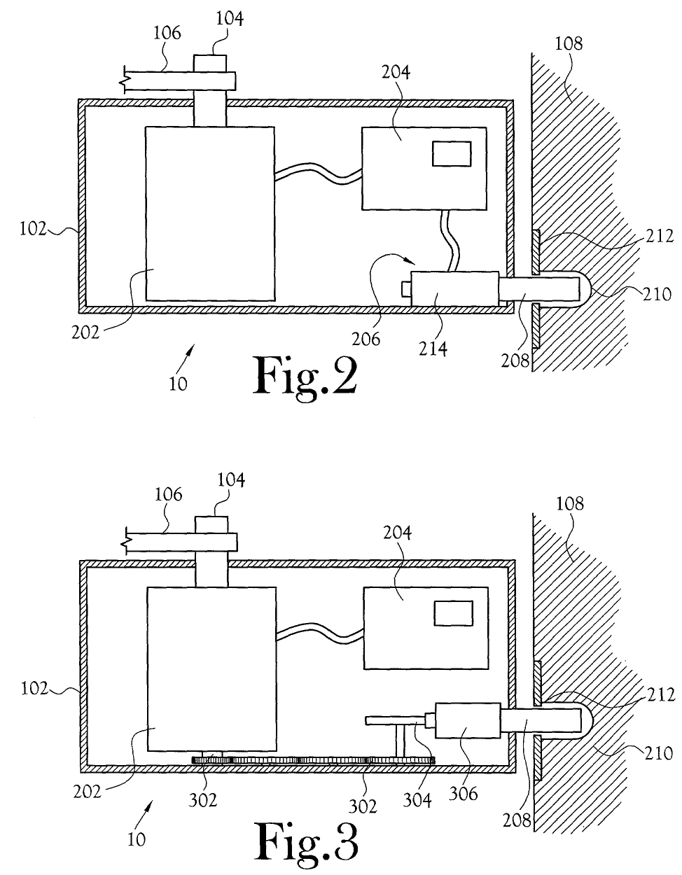

An alternate embodiment of the automatic door system 10 is illustrated in FIG. 3, a mechanical door lock mechanism 306 is shown. A set of gears 302 links the door actuator motor 202 to the door lock mechanism 306. In the illustrated embodiment, the door lock mechanism 306 is a cam 304 operatively connected to the gears 302 operates the locking pin 208. Typically, the locking pin 208 is spring biased to a normally retracted position. The cam 304 applies pressure to the locking pin 208 overcoming the bias to engage the lock or removes pressure from the locking pin 208 to allow the locking pin 208 to retract under the bias. The gears 302 are configured to synchronize the operation of the locking pin 208 with the opening and closing of the door 100. In yet another embodiment, not specifically illustrated, the locking pin 208 is driven directly by a separate motor.

The door lock mechanism 206, 306 is selected to provide security irrespective of other locks used with the door 100. It is intended to serve as a primary lock when the structure is unoccupied and can be supplemented with interior locks, such as door chains, when the structure is occupied. This avoids the need for a separate lock, such as a conventional keyed lock, which would obviate the benefit of virtually hands-free operation. However, for extra security, a deadbolt can be used in conjunction with the door lock mechanism. Typically, the conventional lock is not be part of the automatic door system and is left unlocked; however, the conventional lock can be integrated and activate the automatic door system when the door 100 is unlocked using the key. The automatic door system can also include multiple door lock mechanisms, such as one at the base of the door 100 and one at the top of the door 100. Typically each of the multiple door lock mechanisms are linked to the controller so their operation can be synchronized. Because there is no external access to the lock mechanism, as is provided with a typical keyed lock, the door lock mechanism is generally immune to mechanism bypass mechanisms. However, it should be noted that the electronic security of the door lock mechanism is limited by the sophistication of the identification and authorization schemes implemented by the sensor 110 and the controller.

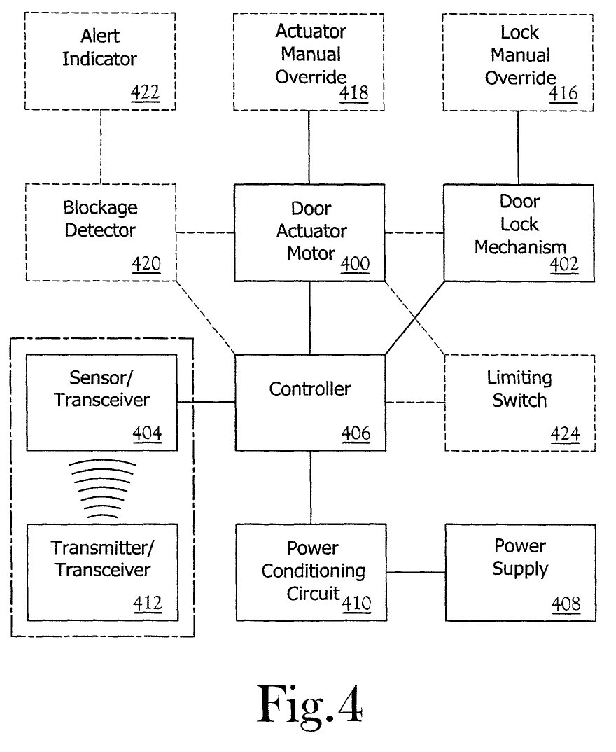

FIG. 4 illustrates a block diagram of the automatic door system 10 of the present invention. The automatic door system 10 includes a motor 400 for driving the door actuator, a locking mechanism 402, and a sensor 404 generally linked by a controller 406. The automatic door system 10 includes a power supply 408. In one embodiment, the power supply 408 includes a step-down transformer driven by standard AC line power. The output of the transformer is conditioned through optional power conditioning circuitry 410. Those skilled in the art will recognize that the power conditioning circuitry 410 can include filters, regulators, surge suppression and/or AC to DC conversion as necessary or desired. The sensor 404 receives a signal from an external source requesting operation of the automatic door system 10. The type of sensor 404 used depends on the anticipated user and the anticipated use of the automatic door system 10. Those skilled in the art will recognize that the available sensor 110 types include, but are not limited to, basic push buttons, keypads, pressure sensitive switches, radio frequency receivers, magnetic sensors, infrared sensors and biometric sensors, such as retinal or fingerprint/palmprint scans and voice activation. Further, those skilled in the art will recognize that multiple sensor types can be used to accommodate multiple access requirements.

Those skilled in the art will recognize that some of the discussed sensor types presuppose an optional corresponding transmitter 412 intended to be carried by a person or animal requesting access from the automatic door system 10, hereinafter, the requestor. The transmitter and sensor pair 414 is generally a pair of matched emitters and detectors or a pair of transmitters and receivers or transceivers. The transmitter 412 is a small device having an internal, portable power supply, i.e., a battery and the ability to send a request that is recognized by the sensor 404 to activate the automatic door system. In one embodiment, the transmitter 412 requires no action by the requestor to communicate with the sensor 404. In another embodiment, the transmitter 412 must be activated to initiate the broadcasting of the request. In a still further embodiment, the requestor carries a transceiver 412 capable of two-way communication to implement addition security verification.

The automatic door system 10 includes a number of safety features. These include manual overrides for both the door lock mechanism 416 and the door actuator mechanism 418. A release disengages the locking pin 208 from the lock driver 214 and allows the locking pin 208 to be retracted to an unlocked position. This provides for access through the door 100 incorporating the automatic door system 10 in the event of an emergency situation, system malfunction or power loss. Similarly, the door actuator mechanism 400 can be disengaged to allow the door 100 to operate in a conventional manual mode. In addition, a blockage detector 420 works in conjunction with the door actuator mechanism 400 to prevent the door 100 from attempting to open or close should the path of the door 100 be blocked. Those skilled in the art will recognize the various sensor types that can be used to implement the blockage detector 420 including, but not limited to, a pressure-sensitive release, a torque sensor and an infrared sensor. For example, the pressure-sensitive release disengages the actuator arm 106 from the door actuator mechanism 400 in the event that a threshold resistance pressure is exceeded. The infrared sensor detects the presence of objects in the path of the door 100 and turns off or reverses the door actuator mechanism 400. Further, those skilled in the art will recognize that the safety features can include an alert indicator 422 to provide warnings, such as an audible warning, that alert someone using the door 100 to a potential problem or alarms to notify and record error conditions and pass that information on to someone who may be monitoring the operation of the door 100 remotely. To this end, those skilled in the art will recognize that the automatic door system could be integrated with a conventional monitored security system.

An automatic door system 10 used with an entry door 100 would require at least a moderate level of security such as a coded radio frequency signal to prevent unwelcome guests from entering the house. However, for an internal door 100 where assistance is needed but security is not required, a pressure sensitive switch would suffice. If the intended users are both pet and human, the user would be required to carry a broadcasting device such as an infrared, magnetic or radio frequency transmitter worn by a pet, for example, on a collar or carried by a human, for example, on a keychain. However, if the intended user is strictly human, the biometric sensor, keypad or other device not operable by a pet could be used. Finally, those skilled in the art will recognize that depending upon the sensor used to activate the automatic door system 10, any number of modulation and coding schemes can be used to communicate with the sensor to provide the desired level of reliability and security.

The controller 406 provides the necessary processing function to verify the identity of the requester for security purposes, to perform authentication functions, to operate the door actuator 400 and to coordinate the activity of the lock mechanism 402. The controller 406 receives and processes the signal received by the sensor 404. In one embodiment, the controller 406 is a microprocessor capable of performing complex logical and mathematical operations for implementing a sophisticated security authentication scheme. Those skilled in the art will recognize that the other components capable of performing logical operations can be substituted for the controller 406 without departing from the scope and spirit of the present invention. Specifically, it is contemplated that the controller 406 could be implemented using discrete logic, a programmable interrupt controller (PIC), an application specific integrated circuit (ASIC), a programmable logic array (PLA) or any other device that allows the desired level of logical decision making or mathematical ability.

By providing direct control over the door actuator mechanism 400, the controller 406 allows the door 100 to be opened and remain open for a specified period of time before closing. Those skilled in the art will recognize that a separate timer circuit (not shown) could also be used without departing from the scope and spirit of the present invention. When combined with requestor identification, this time period can vary to accommodate various users particular needs. Requestor identification is accomplished through any of a variety of techniques. In one embodiment, the sensor 404 is a receiver that receives a radio frequency signal sent by a transmitter 412 carried by the requestor. It is anticipated that the transmitter 412 could continually broadcast the signal; however, continuous broadcast would unnecessarily drain the transmitter power supply. In another embodiment, the requestor carries a transceiver device 412 that receives a first identification request signal continually broadcast from the automatic door system 10 attached to a permanent power source 408. Upon receipt of the request signal, the transceiver 412 then responds with an identification signal. If the controller 406 authenticates the identification signal returned, then the door actuator mechanism 400 is activated. In a still further embodiment, the transmitter 412 requires a manual operation, such as a button to be pressed to initiate the transmission of the identification signal, thereby conserving power. Those skilled in the art will recognize that a manually operated transmitter 412 generally precludes use by animals. In a still further embodiment, requestor identification is accomplished by entering a security code on a keypad or by verification of biometric parameters.

For other less secure applications, a simple magnetic key moved within the sensory range of a magnetic sensor or the application of pressure to a pressure sensitive switch, such as a floor mat, could be used to activate the automatic door system of the present invention. These less secure mechanisms for requestor identification are generally more practical for interior applications where the possible users are known. Such an application is useful to limit access of pets to certain rooms. By way of example, in the case of persons having pet allergies but still desiring to have pets, it is often desirable to prevent the pet from entering certain rooms, such as a bedroom, where the allergy sufferer spends extended periods of time.

The controller 406 provides the capability to assign a profile to a particular requestor that limits access times. For example, the automatic door system 10 could be configured to allow a pet ingress and egress only during specified time periods, such as if a pet is allowed out only during daytime hours. Special codes could be used to allow one-time entry, such as for unattended service calls.

In addition, the automatic door system 10 incorporates an optional position sensor, such as a limiting switch, 424 that controls the movement range of the door 100. The position sensor 424 primarily defines the maximum range of movement for the door 100 and prevents the door actuator mechanism 400 from attempting to move the door 100 beyond a specified position. The position sensor communicates with the controller 406 to limiting the movement of the door. By controlling the door actuator mechanism 400, the controller 406 limits how far the door 100 opens depending upon who is requesting access. For example, when a human requests access, the door 100 opens fully to allow unrestricted access. However, if a pet activates the automatic door system 10, then the door 100 opens some fractional percentage to allow the pet ingress and egress. Those skilled in the art will recognize that multiple limits can be enforced to distinguish between multiple requesters, such as a large dog and a small cat.

An apparatus for automatically actuating and securing a door has been shown and described. The automatic door system non-destructively retrofits a conventional door to allow actuation of the door. The automatic door system integrates a lock mechanism and a door actuation mechanism. The automatic door system allows hands-free operation and is suitable for use with pets or humans. The automatic door system controls the arc of the door swing and duration that the door remains open based upon the requestor activating the automatic door system. The automatic door system provides additional security over traditional mechanical locks. Further, the automatic door system allows access profiles to be customized to the requestor.

While various embodiments have been shown and described, it will be understood that these are not intended to limit the disclosure, but rather they are intended to cover all modifications and alternate methods falling within the spirit and the scope of the invention as defined in the appended claims.

Having thus described the aforementioned invention, I claim:

1. An apparatus for actuating a doorway, the doorway including a door pivotally connected to a frame, said apparatus comprising:
a sensor located proximate to said doorway;
a controller in communication with said sensor;
a lock disposed in the doorway, said lock being releasably engagable to secure the door in a closed position within the frame;
a lock actuator in communication with said controller and with said lock to engage and disengage said lock; and
a door actuator disposed within the doorway, said door actuator in communication with said controller, said door actuator in engagement with the door for opening and closing the door.

2. The apparatus of claim 1 further comprising a blockage detector in communication with said controller, said blockage detector adapted to sense an obstruction in a path of the door.

3. The apparatus of claim 2 wherein said blockage detector includes an infrared sensor, said controller disengaging said door actuator when said infrared sensor sees the obstruction.

4. The apparatus of claim 2 wherein said blockage detector includes a torque sensor, said controller disengaging said door actuator when a torque measured by said torque sensor exceeds a predetermined value.

5. The apparatus of claim 1 further comprising a timer in communication with said controller, said timer counting a time period during which the door is in an open position.

6. The apparatus of claim 5 wherein said controller activates said door actuator to close the door after a predetermined said time period.

7. The apparatus of claim 1 wherein said lock includes a locking pin and the frame defines a cavity adapted to receive said locking pin when said locking pin is in an extended position.

8. The apparatus of claim 7 wherein said lock actuator operates to extend and to retract said locking pin, said lock actuator being selected from the group consisting of a solenoid connected to said locking pin, a cam connected to said door actuator by a set of gears and to said locking pin and a motor connected to said controller and said locking pin.

9. The apparatus of claim 1 wherein said lock actuator includes a lock release for manually extending and retracting said locking pin.

10. The apparatus of claim 1 wherein said sensor is selected from the group consisting of an infrared detector, a radio frequency receiver, a magnetic field detector, a biometric sensor, a keypad and a switch.

11. The apparatus of claim 1 wherein said sensor receives a request to activate said door actuator and passes said request to said controller for further processing.

12. The apparatus of claim 1 further comprising a transmitter adapted to interact with said sensor, said transmitter sending a request to activate said door actuator that is receivable by said sensor.

13. The apparatus of claim 1 wherein said transmitter is carried by a person or an animal, said transmitter sending said request without requiring action by the person or the animal.

14. The apparatus of claim 1 further comprising a position sensor in communication with said controller.

15. An apparatus for actuating a doorway, the doorway including a door pivotally connected to a frame, said apparatus comprising:
means for generating a request for access through the door;
means for verifying said request for access;
means for opening the door;
means for closing the door;
means for locking the door;
means for unlocking the door;
means for synchronizing said means for unlocking the door and means for opening the door; and
means for synchronizing said means for locking the door and means for closing the door.
